(19) United States
(12) Patent Application Publication
(10) Pub. No.: US 2010/0262336 A1
(43) Pub. Date: Oct. 14, 2010

(54) SYSTEM AND METHOD FOR GENERATING AND RENDERING MULTIMEDIA DATA INCLUDING ENVIRONMENTAL METADATA

(75) Inventors: DANIEL M. RIVAS, El Cajon, CA (US); Allen W. Smith, San Diego, CA (US); Eun Hyung Kim, San Diego, CA (US); Paul J. Lafata, San Diego, CA (US); Per O. Nielsen, Chula Vista, CA (US)

Correspondence Address: McDermott Will & Emery LLP, 11682 El Camino Real, Suite 400, San Diego, CA, 92130, US

(73) Assignee: QUALCOMM Incorporated, San Diego, CA (US)

(21) Appl. No.: 12/421,438

(22) Filed: Apr. 9, 2009

(51) Int. Cl. G06F 7/00

(52) U.S. Cl. 701/36; 725/32; 725/75; 701/1

(57) ABSTRACT

A system and method for generating and rendering multimedia data including environmental data is disclosed. In one embodiment, a system for rendering content in a vehicle is disclosed, the system comprising a receiver configure to receive, via a wireless broadcast, audiovisual content and an environmental event associated with a subset of the audiovisual content and a vehicular electronic system configured to render the audiovisual content and alter an environmental parameter in accordance with the environmental event when the associated subset of the audiovisual content is rendered.

### BACKGROUND

Electronic devices, including vehicular entertainment systems, may be configured to receive broadcasts of sports, entertainment, informational programs, or other multimedia content items. For example, audio and/or video data may be communicated using a broadband broadcast communications link to the electronic devices. There is a need to provide a person an enhanced viewing experience on such devices.

### SUMMARY

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the features of this invention provide advantages that include a user experience enhanced by the rendering of environmental metadata.

One aspect of the invention is a method of rendering content in a vehicle, the method comprising receiving, via a wireless broadcast, audiovisual content, receiving, via the wireless broadcast, an environmental event associated with a subset of the audiovisual content, rendering the audiovisual content, and altering an environmental parameter in accordance with the environmental event when the associated subset of the audiovisual content is rendered.

Another aspect of the invention is a system for rendering content in a vehicle, the system comprising a receiver configure to receive, via a wireless broadcast, audiovisual content and an environmental event associated with a subset of the audiovisual content, and a vehicular electronic system configured to render the audiovisual content and alter an environmental parameter in accordance with the environmental event when the associated subset of the audiovisual content is rendered.

Still another aspect of the invention is a method of generating environmental events, the method comprising receiving audiovisual content, analyzing the audiovisual content, generating, automatically, based on the analysis of the audiovisual content, an environmental event associated with a subset of the audiovisual content, transmitting, via a wireless broadcast, the audiovisual content, and transmitting, via the wireless broadcast, the environmental event.

Yet another aspect of the invention is a system for generating environment events, the system comprising an input configured to receive audiovisual content, a processor configure to analyze the audiovisual content and generate, based on the analysis of the audiovisual content, an environmental event associated with a subset of the audiovisual content, and an output configured to transmit the audiovisual content and the environmental event.

### BRIEF DESCRIPTION OF THE DRAWINGS

FIG. 1 is a cut-away diagram of a vehicle.

FIG. 2 is a functional block diagram of a vehicular electronic system.

FIG. 3 is a block diagram illustrating an exemplary system for providing broadcast programming.

FIG. 4A is a flowchart illustrating a method of rendering multimedia content.

FIG. 4B is a diagram illustrating an exemplary data structure for receiving or storing audiovisual content and environmental events.

FIG. 5 is a block diagram illustrating an exemplary system for generating environmental events.

FIG. 6 is a flowchart illustrating a method of generating environmental events.

### DETAILED DESCRIPTION OF THE PREFERRED EMBODIMENT

The following detailed description is directed to certain specific aspects of the invention. However, the invention can be embodied in a multitude of different ways, for example, as defined and covered by the claims. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

A vehicular entertainment system (VES) generally allows the driver and/or passengers of a motor vehicle to experience audio and/or video from the comfort of the vehicle. The first vehicular entertainment systems were simply AM/FM radios connected to a number of speakers. As technology progressed, more sophisticated vehicular entertainment systems developed, included those with the ability to play cassette tapes, CDs, and DVDs. Vehicular entertainment systems may also include mobile receivers configured to receive broadcasts of sports, entertainment, informational programs, or other multimedia content items. For example, audio and/or video data may be communicated using a conventional AM radio broadcast, an FM radio broadcast, a digital radio broadcast, a satellite radio broadcast, a satellite video broadcast, a conventional television broadcast, an ATSC television broadcast, or a high definition television broadcast. Audiovisual data can also be received via a broadband broadcast communications link to a VES or component thereof.

As part of the vehicular electronics, vehicular entertainment systems are generally linked to other vehicular components, such as lighting or climate control, and can take advantage of this connection to further enhance the multimedia experience of rendered content by supplementing the audio or visual content with environmental events such as flashes of light from the lighting system, or streams of warm or cool air from the climate control system.

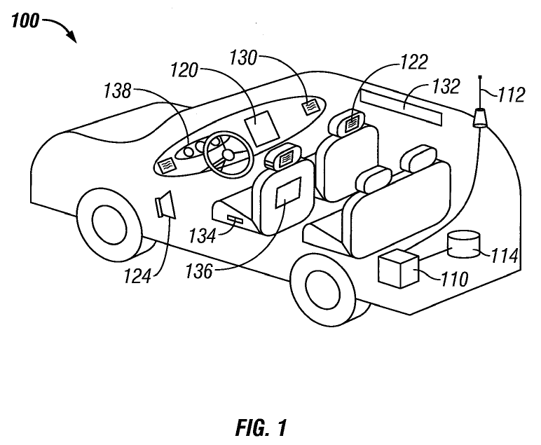

FIG. 1 is a cut-away diagram of a vehicle 100. The vehicle 100 includes a vehicular entertainment system processor 110 configured to receive and process multimedia content. The multimedia content can include audio data, video data, and environmental data. The VES processor 110 can receive data from a number of sources, including via an antenna 112 or a computer-readable storage 114. For example, the VES processor 110 can receive, via the antenna 112, an AM or FM radio broadcast, a digital radio broadcast, a satellite radio broadcast, a satellite video broadcast, a television broadcast, a high definition television broadcast, a ATSC television broadcast, or a broadband digital multimedia broadcast (also known as “mobile TV”), such as a MediaFLO™ broadcast. As a further example, the VES processor 110 can also receive, via the computer-readable storage 114, multimedia data from a cassette tape player, a CD player, a DVD player, MP3 player, or a flash drive.

The VES processor 110 can receive the multimedia data and perform processing on the data for rendering via a vehicle entertainment system. For example, the VES processor can receive video data and process it for rendering on a front console display 120 or one or more rear displays 122. As another example, the VES processor 110 may receive a FM broadcast via the antenna 112, and demodulate the signal for rendering over one or more speakers 124. The VES processor 110 can further receive environmental metadata and submit commands to various vehicular components for rendering of environment data, including the climate control system 130, lighting system 132, seat warmers 134, seat vibrators 136, or the dashboard control system 138.

For example, the VES processor 110 can receive multimedia data of a thunderstorm via the computer-readable storage 114, the multimedia data including audio data, video data, and environmental data. Upon receiving the multimedia data, the VES processor 110 can transmit signals to the speakers 124 to render audio of the storm, and transmit signals to the displays 120, 122 to render video of the storm. The VES processor 110 can further interpret environmental metadata to transmit commands, at the appropriate times, to render environmental events. For example, the environmental metadata can include data regarding the climate control system 130 of the vehicle to, for example, simulate wind. The environmental metadata can include data regarding the lighting system 132 to, for example, enhance the user experience of lightning strikes. The rumbling of thunder can be simulated or enhanced with environmental metadata to a seat vibrator 136.

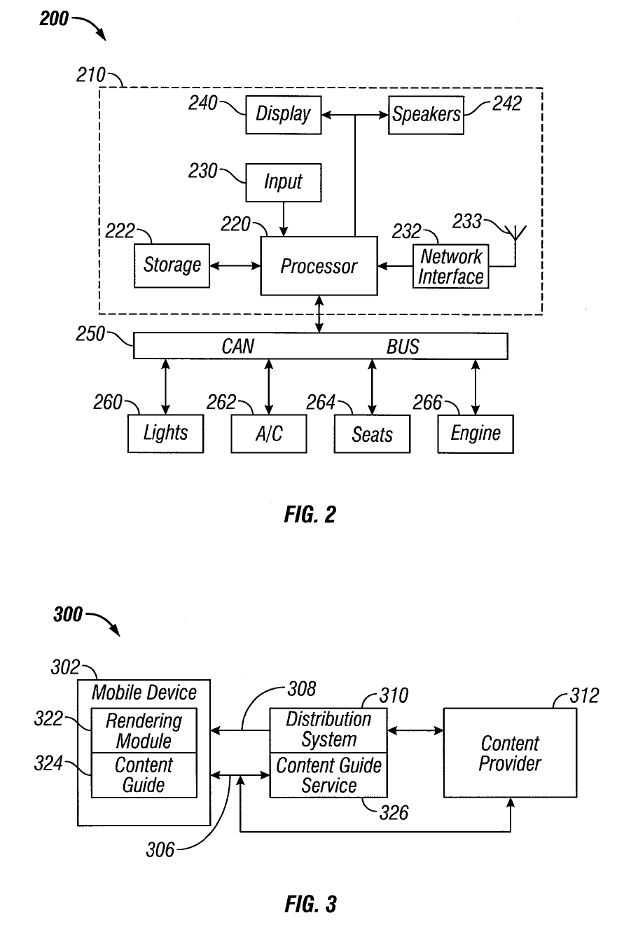

FIG. 2 is a functional block diagram of a vehicular electronic system. The vehicular electronics 200 includes a vehicular entertainment system 210 operatively coupled, via a bus 250 to the rest of the electronics. The VES 210 includes a processor 220, an input 230, a display 242 and speakers 242, storage 222, and an antenna 233 connected via an interface 232. Certain functionalities of the processor 220 have been described with respect to FIG. 1, including the receiving of multimedia data and processing that data. The processor 220 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general purpose processor may be a microprocessor such as an ARM, Pentium®, Pentium II®, Pentium III®, Pentium IV®, Pentium® Pro, an 8051, a MIPS®, a Power PC®, an ALPHA®, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. For example, the processor can comprise a Qualcomm CDMA Technologies (QCT) chipset, such as from the Mobile Station Modem (MSM) chipset family.

The steps of a method or algorithm described in connection with the embodiments disclosed herein may be embodied directly in hardware, in a software module executed by a processor, or in a combination of the two. A software module may reside in any suitable computer readable medium, such as the storage 222. The storage 222 can be a volatile or non-volatile memory such as a DRAM memory, flash memory, ROM memory, EPROM memory, EEPROM memory, registers, hard disk, a removable disk, a CD-ROM, or any other form of suitable storage medium known in the art. An exemplary storage medium is coupled to the processor such the processor can read information from, and write information to, the storage medium. In the alternative, the storage medium may be integral to the processor. The processor and the storage medium may reside in an ASIC or in any suitable commercially available chipset.

The VES processor 220 can be manipulated via an input 230. The input 230 can include, but is not limited to, a keyboard, buttons, keys, switches, a pointing device, a mouse, a joystick, a remote control, an infrared detector, a video camera (possibly coupled with video processing software to, e.g., detect hand gestures or facial gestures), a motion detector, or a microphone (possibly coupled to audio processing software to, e.g., detect voice commands). Video and audio data are output, respectively, via a display 240 and a speaker system 242. The display 240 can include, for example, a touch screen. The display 240 can include a screen in the front of the vehicle for viewing by the driver or front seat passenger. The display 210 can also include one or more screens affixed to the headrest or attached to the ceiling for viewing by a rear seat passenger.

The VES processor 220 can also receive data from an antenna 233 via a network interface 232. The network interface 232 may receive signals according to wireless technologies comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, a MediaFLO™ system, a DMB system, an orthogonal frequency division multiple access (OFDM) system, an ATSC (Advanced Television Systems Committee) system, a satellite receiver-based system, or a DVB-H system.

The VES processor 220 can be connected to one or more interfaces via a controller-area network (CAN bus) 250 or other vehicle bus. A vehicle bus is a specialized internal communications network that interconnects components inside a vehicle (e.g. automobile, bus, industrial or agricultural vehicle, ship, or aircraft). Special requirements for vehicle control such as assurance of message delivery, assured non-conflicting messages, assured minimum time of delivery as well as low cost, EMF noise resilience, redundant routing and other characteristics encourage the use of specific networking protocols.

The CAN bus 250 interconnects the processor 220 with other vehicular subsystems, including the lighting system 260, the climate control system 262, the seats 264, and the engine 266. Environmental metadata can be transmitted to one or more of the subsystems to render environmental events. For example, the lighting system 260 can be made to flash or dim, the climate control system 262 can be made to blow cool or warm air from the vents, the seats 264 can be made to heat, vibrate, or change position, or the engine 266 can be made to start, stop, or rev. For practical purposes, some of these functionalities may not be available for rendering. For example, a user can selectively preclude access to engine functionality or to the position of the seats.

In some embodiments, the system can receive digital broadcast programming, via, e.g., the antenna 233 and network interface 232 of FIG. 2. FIG. 3 is a block diagram illustrating an example system 300 for providing broadcast programming to mobile devices 302 from one or more content providers 312 via a distribution system 310. Although the system 300 is described generally, the mobile device 302 can, for example, be a component of a vehicular entertainment system, such as the VES processor 110 of FIG. 1. Although one mobile device 302 is shown in FIG. 3, examples of the system 300 can be configured to use any number of mobile devices 302. The distribution system 310 can receive data representing a multimedia content item from the content provider 312. The multimedia content items can be communicated over a wired or wireless content item communication link 308. In the context of a vehicular entertainment system, the communication link 308 is generally a wireless radio frequency channel. In one embodiment, the communications link 308 is a high speed or broadband link. In one embodiment, the content provider 312 can communicate the content directly to the mobile device 302 (link not shown in FIG. 3), bypassing the distribution system 310, via the communications link 308, or via another link. It is to be recognized that in other embodiments multiple content providers 312 can provide content items via multiple distribution systems 310 to the mobile devices 302 either by way of the distribution system 310 or directly.

In the example system 300, the content item communication link 308 is illustrated as a uni-directional network to each of the vehicular entertainment system components 302. However, the content item communication link 308 can also be a fully symmetric bi-directional network.

In the example system 300, the mobile devices 302 are also configured to communicate over a second communication link 306. In one embodiment, the second communication link 306 is a two way communication link. In the example system 300, however, the link 306 can also comprise a second link from the mobile device 302 to the distribution system 310 and/or the content provider 312. The second communication link 306 can also be a wireless network configured to communicate voice traffic and/or data traffic. The mobile devices 302 can communicate with each other over the second communication link 306. Thus, the vehicular entertainment systems may be able to communicate vehicle-to-vehicle as part of the system. Alternatively, this may enable a mobile phone to communicate with the vehicular entertainment system. The communication link 306 can also communicate content guide items and other data between the distribution system 310 and the mobile devices 302.

The communication links 306 and 308 can comprise one or more wireless links, including one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, a MediaFLO™ system, a DMB system, an orthogonal frequency division multiple access (OFDM) system, an ATSC system, a satellite receiver-based system, or a DVB-H system.

In addition to communicating content to the mobile device 302, the distribution system 310 can also include a program guide service 326. The program guide service 326 receives programming schedule and content related data from the content provider 312 and/or other sources and communicates data defining an electronic programming guide (EPG) 324 to the mobile device 302. The EPG 324 can include data related to the broadcast schedule of multiple broadcasts of particular content items available to be received over the program communication link 308. The EPG data can include titles of content items, start and end times of particular broadcasts, category classification of programs (e.g., sports, movies, comedy, etc.), quality ratings, adult content ratings, etc. The EPG 324 can also include whether environmental metadata is available for a particular program. The EPG 324 can be communicated to the mobile device 302 over the program communication link 308 and stored on the mobile device 302. For example, the EPG 324 can be stored in storage 222 of FIG. 2.

The mobile device 302 can also include a rendering module 322 configured to render the multimedia content items received over the content item communication link 308. The rendering module 322 can include analog and/or digital technologies. The rendering module 322 can include one or more multimedia signal processing systems, such as video encoders/decoders, using encoding/decoding methods based on international standards such as MPEG-x and H.26x standards. Such encoding/decoding methods generally are directed towards compressing the multimedia data for transmission and/or storage. The rendering module 322 can be a component of the processor 220 or FIG. 2 of the VES processor 110 of FIG. 1.

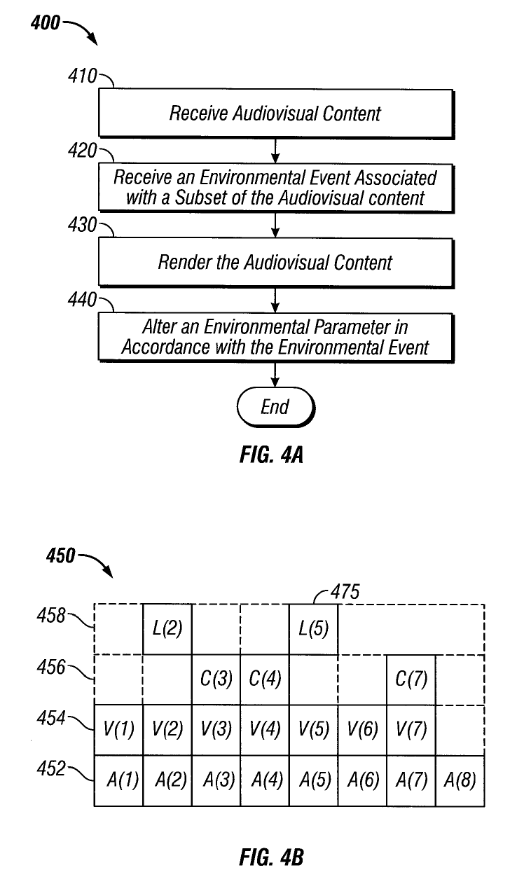

FIG. 4A is a flowchart illustrating a method 400 of rendering multimedia content. The method 400 begins, in block 410, with the system, such as the vehicle 100 of FIG. 1, receiving audiovisual content. Although the method 400 is described below with respect to the vehicle 100 of FIG. 1, it is understood that other systems, such as the vehicular electronics 200 of FIG. 2, could perform the disclosed method. As an example of receiving audiovisual content, the VES processor 110 of FIG. 1 can receive an AM broadcast via the antenna 112. The audiovisual content can include audio data, video data, or both. Continuing to block 420, the system receives an environmental event associated with a subset of the audiovisual content. In general, a subset may include only one element of the set, at least two elements of the set, at least three elements of the set, a significant portion (e.g. at least 10%, 20%, 30%) of the elements of the set, a majority of the elements of the set, nearly all (e.g., at least 80%, 90%, 95%) of the elements of the set, all but two, all but one, of all of the elements of the set. The environmental event can be associated with a specific time interval or a specific time. For example, the environmental event can prescribe that the climate control system is to activate, blowing warm air, for five seconds. The environmental event can prescribe that the lighting system flash the dome light at a specific time.

Audio-video synchronization refers to the relative timing of audio (sound) and video (image) portions during creation, post-production (mixing), transmission, reception and play-back processing. A digital or analog audiovisual stream or file can contain some sort of explicit AV-sync timing, either in the form of interlaced video and audio data or by explicit relative time-stamping of data. The environmental metadata can be similarly synchronized with the playback of audio or video data using these techniques.

For example, the audiovisual data may include time stamps indicating when particular portions of the audio or video data should be rendered. The environmental metadata can similarly have time stamps to facilitate rendering the events with the audiovisual content with which they are associated.

Although blocks 410 and 420 are shown and described subsequently, in some embodiments, the audiovisual content and environmental events are received concurrently, in the same broadcast, or as parts of the same data file.

In one embodiment, the audiovisual content and environmental events are received in the form of a particular data structure. The data structure can be list, a graph, or a tree. FIG. 4B is a diagram illustrating an exemplary data structure 450 for receiving or storing audiovisual content and environmental events. The data structure 450 comprises a number of tracks, including an audio track 452, a video track 454, a climate track 456, and a lighting track 458. Each track is partitioned into a number of frames 475, each frame containing data renderable by the appropriate vehicular component.

This data structure has a number of particular advantages. The data structure 450 is decomposable in time, meaning that particular time intervals can be read separately from the data structure. This allows a system to pause, fast-forward, or rewind the data structure 450. As the data structure 450 is linear in time, such a data structure could be streamed, i.e., partially rendered before the entire data structure is received. As each track of the data structure 450 is partitioned into a number of frames 475, synchronization is simplified, as each frame has a shared starting point along the tracks.

The data structure 450 is also decomposable by track, meaning that particular tracks can be read while other tracks are ignored. For example, the vehicular entertainment system may have environment events disabled, which can be accomplished by ignoring the climate track 456 and the lighting track 458. If the vehicle is in motion and required to not display video data or render environmental events, the audio track 452 alone could be read from the data structure 450. Because the data structure 450 is decomposable by track, the environmental events can be transmitted separately from the audiovisual content and still synchronized by frame.

In the illustrated embodiment, each track does not contain data at all frames. For example, the climate track 456 does not contain data at frames 1 or 2, but does contain data at frames 3 and 4. In other embodiments, each track contains data at each frame, even if the data contains instructions to do nothing, or comprises the all-zeroes vector.

After the audiovisual content and environmental events have been received, in blocks 410 and 420 respectively, the system renders the audiovisual content block 430. For example, the system can play audio content via the speakers 242 of FIG. 2. As another example, the system can display video content on the display 240 of FIG. 2. Continuing to block 440, the system alters an environmental parameter in accordance with the environmental event. The environmental parameters can include, for example, the temperature of the vehicle, the lighting conditions of the vehicle, the position of the seats, etc. The environmental parameters can be altered by the various subsystems of the vehicle, including the climate control system and lighting system.

Rendering of environmental events can be conditioned upon preprogrammed criteria. For example, rendering of environmental events can be conditioned upon user preferences. In one embodiment, the vehicular entertainment system is provided with a graphical user interface. Via this interface, a user can indicate that environmental events are not to be rendered. In other embodiments, the user can indicate that only specific environmental events are to be rendered, e.g. that environmental events involving the climate control system are not be rendered, but that those involving the lighting system are to be rendered. These preferences can be stored, for example, in the storage 222 of FIG. 2.

In another embodiment, certain environmental events are associated with an intensity which can be used to further specify user preferences. For example, an environmental event can comprise instructions to activate the air conditioning system to produce cold air. The environmental event can further comprise an indication that the air conditioning system should be set to “HIGH” or to some numerical value. User preferences can indicate that environmental events with an intensity above some threshold should not be rendered. User preferences can also indicate that such events should be rendered at the threshold level. User preferences can also modulate the intensity of environmental events. For example, an environmental event set to a level of 10 can be rendered at an equivalent level of 5, whereas an environmental event set to a level of 6 can be rendered at an equivalent level of 3, based on a user-defined setting.

Other preprogrammed criteria can be used alter or prevent the rendering of environmental events. For example, there may be legal prescriptions against using the dome light while the vehicle is in motion. The system can detect, for example via the CAN bus 250 of FIG. 2, that the vehicle is in motion and disable rendering of environmental events involving the lighting system. In some embodiments, environmental events are only rendered when the vehicle is in park. Thus, the system determines whether the vehicle is in park prior to rendering any environmental event.

The rendering of an environmental event may be specific to a single user's position in the vehicle. For example, an environmental event can include instructions to warm the seats of the driver and front passenger. The environmental event can include instructions to warm only one of the front seats. Even in the first case, in which the instructions are to warm both front seats, user preferences may preclude rendering of the environmental event according to the instructions. For example, the driver may indicate that such environmental events are not to be rendered, whereas the front passenger indicates that such environmental events are to be rendered. Similarly, environmental events involving climate control may be limited to the front or rear seats only, or to particular vents.

Although blocks 430 and 440 are shown and described subsequently, in some embodiments, the audiovisual content is rendered and the environmental parameter is altered concurrently.

The system can receive a data file or a data stream comprising an audiovisual component and an associated environmental event. The environment event can be associated, for example, by the use of time stamps, in that both the audiovisual content and the environmental event are programmed to be rendered concurrently, or closely in time. A system and method for generating of such a data file or data stream is described below.

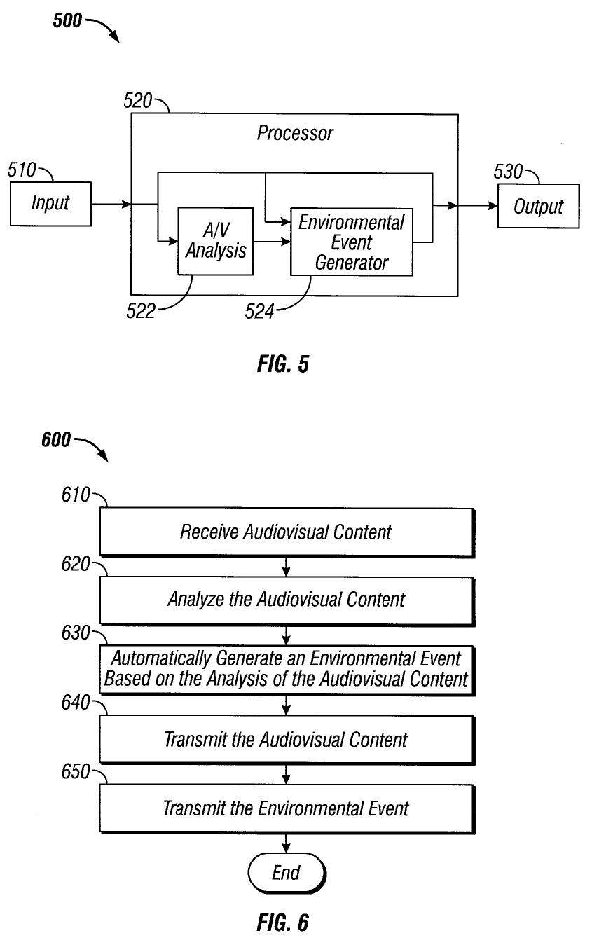

FIG. 5 is a block diagram illustrating an exemplary system for generating environmental events. The system 500 comprises an input 510, a processor 520, and an output 530. The system 500 can be housed, for example, at the content provider 312 of FIG. 3, or be a component of the VES processor 110 of FIG. 1.

The input 510 is generally configured to receive audiovisual data and provide the data to the processor. The audiovisual data may derive from a computer-readable storage or be received from a remote source via a wired or wireless communications link. The processor 520 is generally configured to process the received data and to generate environmental events associated with subsets of the received data. The processor 520 can include an audiovisual analysis module 522 and an environmental event generating module 524.

The audiovisual analysis module 522 receives the audiovisual data and performs analysis upon it to generate metric data for the environmental event generator 524. The audiovisual analysis module 522 can further include an audio or video decoder in order to analyze coded data, such as compressed data. For example, audio data can be received in MP3 format. The audiovisual analysis module 522 can decode this data into its representative waveform and perform analysis upon it. For example, the audiovisual analysis module 522 can produce a variable volume metric over time. The environmental event generator 524 receives metric data from the audiovisual analysis module 522 and generates environmental events based on the metric data. For example, if the audiovisual analysis module 522 outputs a volume over time, the environmental event generating module 524 can generate an environmental event to turn on a seat vibrator when the volume surpasses a certain level. The environmental events can be time-stamped to associate them with the particular portion of the audiovisual data.

In one embodiment, the environmental events are generated and output separately from the audiovisual data. In such an embodiment, the processor 520 transmits both the audiovisual data and the environmental events to the output 530. In another embodiment, the environment event generating module 524 processes the input audiovisual data and encodes a single file or stream comprising both the audiovisual data and the environmental events. In such an embodiment, the processor 520 transmits the file or stream to the output 530.

The output 530 is a device configured to store or transmit the output from the processor. The output 530 can store the data from the processor 520 in a computer-readable medium. For example, the data can be burned to a CD-ROM, or stored on a magnetic disk drive. In another embodiment, the data from the processor 520 is transmitted, e.g. by the content provider 312 to the distribution system 310 of FIG. 3. In another embodiment, the environmental events are added by the distribution system 310 of FIG. 3 and transmitted, via the link 308 to one or more mobile devices 302.

FIG. 6 is a flowchart illustrating a method of generating environmental events. The method 600 begins, in block 610, with the reception of audiovisual content. For example, the system 500 of FIG. 5 can receive audiovisual content via the input 510. Next, in block 620, the system analyzes the audiovisual content. In one embodiment, this analysis is performed by the audiovisual analysis module 522 of FIG. 5.

Analysis of the audiovisual content can include analysis of audio data, video data, or both simultaneously, to produce time-dependent metrics for further use. For example, analysis of audio data can include deriving a volume over time or a spectrogram. Analysis of video data can include determining a luminance or brightness of the video content over time. For example, the luminance value of each pixel of a frame could be summed to produce a luminance value. If this is done for each frame, or for a subset of the frames, a luminance value over time is created.

Analysis of video data can also include determining a color scheme of the video over time. For example, the color of each pixel of a frame could be given a color-dependent weight, which is summed for each frame, or a subset thereof, to produce a color scheme value which varies with frame number or time. For example, the colors red, orange, and yellow are generally thought of as “warm” colors, whereas blue and purple are generally thought of as “cool” colors. If red, orange, and yellow are given positive weights and blue and purple are given negative weights, “warm” color schemes will generally yield a positive color scheme value, whereas “cool” color schemes will generally yield a negative value. Color could also be analyzed to determine a color consonance value. Complementary colors are pairs of colors that are of “opposite” hue in some color model. For example, complementary pairs of the blue-yellow-red color wheel include blue and orange, yellow and purple, and red and green. Complementary colors are thought to stand out against each other. Analog colors, those similar to each other, are thought to have a harmonious feel. Analysis could be performed on a frame of video to determine if the use of complementary or analog colors has resulted in a jarring look or a harmonious look.

In another embodiment, analysis of audiovisual data includes object detection and/or object classification. Object classification is the act of classifying a data sample into one or more object classes. Thus, a classifier receives a data sample and provides additional information about that sample, particularly, whether or not the sample is representative of a particular object. The data sample may comprise a data measurement such as temperature, pressure, or attendance at a sports stadium. The data sample may also be a data vector combining a number of data measurements. The data sample may also be a sound clip, a digital image, or other representation of perceptual media. For example, a data sample comprising a sound clip of music may classify the sample as belonging to a “Classical” object class, a “Rock/Pop” object class, or an “Other” object class. Classifying the sample as a “Classical” object indicates that the sound clip is representative of other “Classical” objects, which would be, e.g., other sound clips of classical music. One could thus infer that the data sample is a sound clip of classical music, or at least shares a number of characteristics of classical music, based on the computer-generated classification into the “Classical” object class.

There are many ways to represent a class of objects, e.g. from shape analysis, bag-of-words models, or local descriptors such as SIFT (Scale-Invariant Feature Transform). Examples of classifiers are Naive Bayes classifier, SVM (Support Vector Machine), mixtures of Gaussian, and neural networks.

Object detection is a computer technology related to computer vision and image processing that deals with detecting instances of semantic objects of a certain class (such as humans, buildings or cars) in digital images and videos.

In one embodiment, an audio portion of the audiovisual content is classified and the generation of environmental events is based upon the classification. For example, if a sound file is classified as “Music,” an environmental event to activate a seat vibrator at particular times corresponding to beats may be generated. In another embodiment, a video portion of the audiovisual content is analyzed to detect a particular object (snow, explosions, flames, etc.) and environmental events are generated based on the detection.

Using the metrics derived from the analysis environmental events are automatically generated in block 630. For example, if the volume at a particular time increases over some threshold value, an environmental event to activate a seat vibrator can be generated. As another example, environmental events relating to climate control could be generated based on a color scheme value. For example, when the video displays a “cool” color scheme, an environmental event can be generated which instructs the climate control system to lower the temperature, whereas when the video displays a “warm” color scheme, an environmental event can be generated which instructs the climate control system to increase the temperature. As another example, if the luminance level increases with a specific rapidity, indicating a flash on the screen, an environmental event could be generated instructing the dome light to also flash.

Finally, in blocks 640 and 650 respectively, the audiovisual content and associated environmental events are transmitted. The transmission can, for example, be performed by the output 530 of FIG. 5.

Although automatic generation of environmental events has been described herein, it is to be understood that the methods of rendering audiovisual content and associated audiovisual events is not limited to data so generated. For example, environment events could be generated by a person to program a unique multimedia experience.

While the above detailed description has shown, described, and pointed out novel features of the invention as applied to various aspects, it will be understood that various omissions, substitutions, and changes in the form and details of the device or process illustrated may be made by those skilled in the art without departing from the scope of this disclosure. As will be recognized, the invention may be embodied within a form that does not provide all of the features and benefits set forth herein, as some features may be used or practiced separately from others. The scope of this disclosure is defined by the appended claims, the foregoing description, or both. All changes which come within the meaning and range of equivalency of the claims are to be embraced within their scope.

What is claimed is:

1. A method of rendering content in a vehicle, the method comprising:
receiving, via a wireless broadcast, audiovisual content;
receiving, via the wireless broadcast, an environmental event associated with a subset of the audiovisual content;
rendering the audiovisual content; and
altering an environmental parameter in accordance with the environmental event when the associated subset of the audiovisual content is rendered.

2. The method of claim 1, wherein altering the environmental parameter comprises transmitting instructions to a climate control unit of the vehicle.

3. The method of claim 1, wherein altering the environmental parameter comprises transmitting instructions to warm a seat of the vehicle.

4. The method of claim 1, wherein altering the environmental parameter comprises transmitting instruction to induce vibration of a seat of the vehicle.

5. The method of claim 1, further comprising, prior to altering the environmental parameter, determining that a user has indicated that environmental events are to be rendered.

6. The method of claim 1, further comprising, prior to altering the environmental parameter, determining an intensity of the environmental event.

7. The method of claim 6, further comprising, prior to altering the environmental parameter, changing the intensity of the environmental event based on user preferences.

8. The method of claim 6, further comprising, prior to altering the environmental parameter, determining a user-defined threshold and determining that the intensity is below or equal to the threshold.

9. The method of claim 1, further comprising, prior to altering the environmental parameter, determining a state of the vehicle.

10. A system for rendering content in a vehicle, the system comprising:
a receiver configure to receive, via a wireless broadcast, audiovisual content and an environmental event associated with a subset of the audiovisual content; and
a vehicular electronic system configured to render the audiovisual content and alter an environmental parameter in accordance with the environmental event when the associated subset of the audiovisual content is rendered.

11. The system of claim 10, wherein the receiver is configured to receive a digital multimedia broadcast.

12. The system of claim 10, wherein the vehicular electronic system comprises a vehicular entertainment system upon which the audiovisual content is rendered.

13. The system of claim 12, wherein the vehicular entertainment system comprises at least one of a display or a speaker upon which the audiovisual content is rendered.

14. The system of claim 10, wherein the vehicular electronic system comprises at least one of a climate control system, a vehicular lighting system, or a seat control system via which the environmental parameter is altered.

15. A system for rendering content in a vehicle, the system comprising:
means for receiving, via a wireless broadcast, audiovisual content and an environmental event associated with a subset of the audiovisual content;
means for rendering the audiovisual content; and
means for altering an environmental parameter in accordance with the environmental event when the associated subset of the audiovisual content is rendered.

16. The system of claim 15, wherein the means for receiving comprises at least one of an antenna, a network interface, a computer-readable storage, or a processor; the means for rendering comprises at least one of a display, a speaker, or a processor; or the means for altering an environmental parameter comprises at least one of a climate control system, a lighting system, a seat control system, or a processor.

17. A method of generating environmental events, the method comprising:
receiving audiovisual content;
analyzing the audiovisual content;
generating, automatically, based on the analysis of the audiovisual content, an environmental event associated with a subset of the audiovisual content;
transmitting, via a wireless broadcast, the audiovisual content; and
transmitting, via the wireless broadcast, the environmental event.

18. The method of claim 17, wherein analyzing the audiovisual content comprises determining, for a subset of the audiovisual content, at least one of a volume, a luminance, a color scheme, or a color consonance.

19. The method of claim 17, wherein the environmental event comprises instructions to alter an environmental parameter via a vehicular climate control system, a vehicular lighting system, or a vehicular seat control system.

20. The method of claim 17, wherein transmitting the audiovisual content and transmitting the environment event comprises transmitting a data structure comprising a plurality of tracks, each track decomposable into a plurality of frames.

21. A system for generating environment events, the system comprising:
a processor configure to analyze audiovisual content and generate, based on the analysis of the audiovisual content, an environmental event associated with a subset of the audiovisual content, wherein the environmental event comprises instructions to alter an environmental parameter via a vehicular component; and
a transmitter configured to wireless transmit the audiovisual content and the environmental event.

22. A system for generating environmental events, the system comprising:
means for receiving audiovisual content;
means for analyzing the audiovisual content;
means for generating, automatically, based on the analysis of the audiovisual content, an environmental event associated with a subset of the audiovisual content; and
means for transmitting, via a wireless broadcast, the audiovisual content and the environmental event.

23. The system of claim 22, wherein the means for receiving comprises at least one of an antenna, a network interface, a computer-readable storage, or a processor; the means for analyzing comprises at least one of a processor or an audiovisual analysis module; the means for generating comprises at least one of a processor or an environmental event generator; or the means for transmitting comprises at least one of a antenna, a network interface, a computer-readable storage, or a processor.
